(19) United States
(12) Patent Application Publication
(10) Pub. No.: US 2023/0382403 A1
(43) Pub. Date: Nov. 30, 2023

(54) SYSTEM FOR ESTIMATING VEHICLE VELOCITY BASED ON DATA FUSION

(71) Applicant: GM Global Technology Operations LLC, Detroit, MI (US)

(72) Inventors: Hualin Tan, Novi, MI (US); Paul Guillermo Otanez, Franklin, MI (US); SeyedAlireza Kasaiezadeh Mahabadi, Novi, MI (US); Bharath Pattipati, South Lyon, MI (US); Ruixing Long, Novi, MI (US); Lapo Frascati, Dicomano (IT); Giulio Boni, Scandicci (IT)

(21) Appl. No.: 17/824,444

(22) Filed: May 25, 2022

(51) Int. Cl. B60W 40/105; B60W 40/06; B60W 50/02; B60W 50/14; G06V 20/56

(52) U.S. Cl. CPC B60W 40/105; B60W 40/06; B60W 50/0205; B60W 50/14; G06V 20/588; B60W 2050/0083

(57) ABSTRACT

A system for estimating a lateral velocity and a longitudinal velocity of a vehicle includes a plurality of sensors for monitoring data indicative of a travel state of the vehicle and one or more controllers in electronic communication with the plurality of sensors. The one or more controllers executes instructions to receive the data indicative of the travel state of the vehicle from the plurality of sensors. The one or more controllers estimate at least one initial estimated state of the vehicle based on the data indicative of the travel state of the vehicle. The one or more controllers fuse together the data indicative of the travel state of the vehicle with the at least one initial estimated state of the vehicle to determine the lateral velocity and a longitudinal velocity of the vehicle based on a single state estimation scheme.

### INTRODUCTION

The present disclosure relates to a system for estimating longitudinal and lateral velocity of a vehicle by fusing data collected from a plurality of sensors and vehicle states that are estimated based on various estimation schemes, where the data fusion is performed based on a single state estimation scheme.

Many vehicles today are equipped with motion control systems for enhancing driver control. Vehicle motion control systems rely upon several basic states of the vehicle such as, for example, estimated longitudinal and lateral velocity, under various operating conditions. In general, longitudinal velocity is determined based on angular wheel speed measurements taken by wheel speed sensors. One issue with using a longitudinal velocity calculated from wheel speed is that the calculated longitudinal velocity may not always be equal to the actual or true vehicle velocity during some types of operating conditions. For example, when the vehicle is traveling on wet, snowy, or icy roads, the vehicle's wheels tend to slip. As a result of the wheel slippage, the longitudinal velocity estimated based on the wheel speed measured from the wheel speed sensors may differ from the actual longitudinal velocity.

In addition to the above-mentioned challenges, it may not be possible to accurately estimate of the longitudinal velocity may when the vehicle is traveling at very low speeds. An accurate estimate of the longitudinal velocity may also not be possible when the wheel speed sensors are inoperable or otherwise unable to record data.

Thus, while current systems achieve their intended purpose, there is a need in the art for an improved approach for estimating longitudinal and lateral velocity under varying operating conditions.

### SUMMARY

According to several aspects, a system for estimating a lateral velocity and a longitudinal velocity of a vehicle including a plurality of sensors for monitoring data indicative of a travel state of the vehicle is disclosed. The system includes one or more controllers in electronic communication with the plurality of sensors. The one or more controllers execute instructions to receive the data indicative of the travel state of the vehicle from the plurality of sensors. The one or more controllers estimate at least one initial estimated state of the vehicle based on the data indicative of the travel state of the vehicle, and fuse together the data indicative of the travel state of the vehicle with the at least one initial estimated state of the vehicle to determine the lateral velocity and a longitudinal velocity of the vehicle based on a single state estimation scheme.

In another aspect, the data indicative of the travel state of the vehicle includes an angular wheel speed velocity of one or more wheels of the vehicle.

In another aspect, the data indicative of the travel state of the vehicle includes a yaw rate and a body acceleration of the vehicle.

In yet another aspect, the at least one initial estimated state of the vehicle is an initial longitudinal velocity of the vehicle.

In an aspect, the one or more controllers execute instructions to estimate the initial longitudinal velocity based on a corner wheel velocity estimate and a wheel status signal.

In another aspect, the one or more controllers execute instructions to estimate the initial longitudinal velocity based on global positioning system (GPS) signals.

In yet another aspect, the one or more controllers execute instructions to collect raw image data of an environment surrounding the vehicle and determine a lateral deviation and road curvature based on the raw image data, wherein the lateral deviation and the road curvature are virtual measurements.

In an aspect, the one or more controllers execute instructions to receive one or more notifications that the vehicle is undergoing a specific reset event and in response to receiving the one or more notifications, reset at least a portion of an initial state estimate and an associated initial state error covariance.

In another aspect, the one or more controllers execute instructions to reset the initial state estimate and the associated initial state error covariance to either last known values or initialization values.

In yet another aspect, the one or more controllers execute instructions to reset the initial state estimate and the associated initial state error covariance by re-computing the initial state estimate and the associated initial state error covariance.

In an aspect, the one or more notifications include one or more of the following: a restart indicator and an inoperable sensor indicator.

In another aspect, the restart indicator is represented as a Boolean variable and indicates when the vehicle or the one or more controllers have restarted.

In yet another aspect, the inoperable sensor indicator indicates that one or more of the plurality of sensors are inoperable.

In an aspect, the one or more controllers execute instructions to re-compute the initial state estimate and the associated initial state error covariance based on grade and surface values.

In another aspect, the grade and surface values include at least one of the following: a road angle, a bank angle, and a coefficient of friction.

In yet another aspect, the one or more controllers execute instructions to adjust a process noise covariance matrix and a measurement noise covariance matrix for each time step based on one or more process and noise variables related to the plurality of sensors and a vehicle mode.

In an aspect, the one or more process and noise variables include one or more of the following: include sensor confidence interval information, measurement underweighting information, and process and measurement noise gain scheduling.

In another aspect, the one or more controllers execute instructions to compare the sensor confidence interval information with the data collected from the plurality of sensors indicating the travel state of the vehicle. The one or more controllers calculate a reliability and confidence level of the data collected from the plurality of sensors based on the sensor confidence interval information, and determine a sensor fault based on the comparison between the sensor confidence interval information and the data collected from the plurality of sensors indicating the travel state of the vehicle.

In an aspect, the one or more controllers execute instructions to in response to determining the sensor fault, generate measurement underweighting information that weights the process noise covariance matrix and the measurement noise covariance matrix.

In another aspect, the single state estimation scheme is one of the following: extended Kalman filter, an unscented or sigma-point Kalman filter, a particle filter, an information filter, and an interacting multiple model filter or the corresponding square-root implementation

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle including the disclosed system for estimating longitudinal and lateral velocity, where the system includes one or more controllers in electronic communication with a plurality of sensors, according to an exemplary embodiment; and

FIG. 2 is a block diagram of the one or more controllers shown in FIG. 1, according to an exemplary embodiment.

### DETAILED DESCRIPTION

The following description is merely exemplary in nature and is not intended to limit the present disclosure, application, or uses.

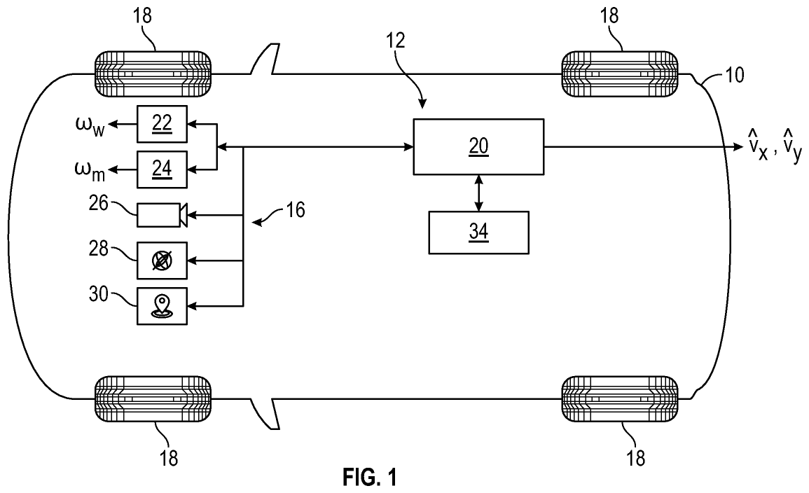

Referring to FIG. 1, an exemplary vehicle 10 including a system 12 for estimating a lateral and longitudinal velocity is illustrated. The vehicle 10 may be any type of vehicle such as, but not limited to, a sedan, truck, sport utility vehicle, van, a ride-share vehicle, or motor home. The system 12 includes one or more controllers 20 in electronic communication with a plurality of sensors 16 monitoring data indicative of a travel state of the vehicle 10. The travel state of the vehicle 10 includes any data or signals that are indicative of the movement of the vehicle 10. In the non-limiting embodiment as shown in FIG. 1, the plurality of sensors 16 include one or more wheel speed sensors 22 for measuring an angular wheel speed velocity ω_{w} of one or more wheels 18 of the vehicle 10, a motor speed sensor 24 for measuring a motor speed ωₘ of a prime mover of the vehicle 10, one or more cameras 26, an inertial measurement unit (IMU) 28, and a global positioning system (GPS) 30. It is to be appreciated that additional sensors may be used as well such as, for example, steering angle sensors. The one or more controllers 20 are also in electronic communication with one or more vehicle controllers 34, where the vehicle controllers 34 correspond to other vehicle systems that are part of the vehicle 10.

As explained below, the disclosed system 12 executes a real-time algorithm for estimating a longitudinal velocity [symbol] and a lateral velocity [symbol] of the vehicle 10 by fusing together the data collected from the plurality of sensors 16 in combination with one or more initial vehicle states that are estimated using multiple estimation schemes, where the data fusion is based on a single state estimation scheme. The disclosed system 12 provides an accurate estimate of the longitudinal velocity [symbol] and the lateral velocity [symbol] under varying operating conditions as well when one or more sensors of the vehicle 10 are inoperable or provide uncertain data. In addition to the longitudinal velocity [symbol] and the lateral velocity [symbol] , the system 12 also determines a longitudinal acceleration measurement offset dₓ, and a lateral acceleration measurement offset d_{y}. The system 12 may compensate for sensor uncertainty through disturbance estimates, such as the longitudinal and lateral acceleration measurement offsets dₓ, d_{y}.

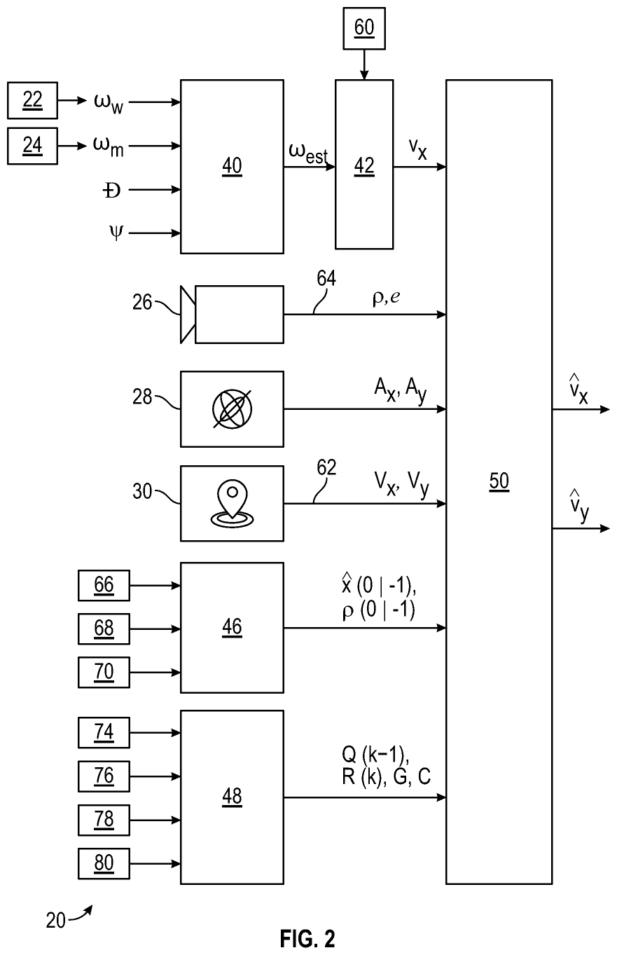

FIG. 2 is a block diagram illustrating the one or more controllers 20 shown in FIG. 1, where the one or more controllers 20 include a corner wheel estimation module 40, a corner-based vehicle body speed module 42, a state and covariance restart block 46, a covariance arbitration and adaptation block 48, and a state estimator block 50. As explained below, the state estimator block 50 fuses data from multiple inputs to estimate the lateral velocity [symbol] and the longitudinal velocity [symbol] .

Referring to FIGS. 1 and 2, the corner wheel estimation module 40 receives as input the angular wheel speed velocity ω_{w} measured by the wheel speed sensors 22, driveline dynamics D, motor speed ωₘ from the motor speed sensors 24, and the yaw rate ψ from the IMU 28. The angular wheel speed velocity ω_{w} indicates the angular wheel speed of one or more wheels 18 of the vehicle 10. The driveline dynamics D include nonlinear dynamics of a drivetrain of the vehicle 10 that indicate factors such as, but not limited to, lash, clunk, and half-shaft torsion dynamics. The corner wheel estimation module 40 converts the motor speed ωₘ into the angular wheel speed velocity ω_{w} based on the driveline dynamics D, as the motor speed ωₘ provides a higher level of resolution and accuracy. The corner wheel estimation module 40 determines a corner wheel velocity estimate ωₑₛₜ of one or more wheels 18 of the vehicle 10 (FIG. 1) based on the angular wheel speed velocity ω_{w} from the wheel speed sensors 22, the driveline dynamics D, the motor speed ωₘ from the motor speed sensors 24, and a yaw rate ψ from the IMU 28.

The corner-based vehicle body speed module 42 receives as input the corner wheel velocity estimate ωₑₛₜ from the corner wheel estimation module 40 and a wheel status signal 60 from the one or more vehicle system controllers 34 (FIG. 1) and estimates an initial longitudinal velocity Vₓ of the vehicle 10 based on the input. The initial longitudinal velocity Vₓ is utilized as a virtual measurement by the state estimator block 50. The wheel status signal 60 includes wheel stability flags, which indicate wheel slip conditions in the wheels 18. It is to be appreciated that errors may be introduced when estimating in the initial longitudinal velocity Vₓ may occur due to wheel slip, and the wheel status signal 60 accounts for the wheel slip. Thus, the system 12 estimates at least one initial estimated state of the vehicle 10 based on the data indicative of the travel state of the vehicle collected by the plurality of sensors 16 (FIG. 1), where the plurality of sensors 16 include at least the wheel speed sensors 22 and the IMU 28.

The one or more cameras 26 collect image data 64 of the environment surrounding the vehicle 10. In one embodiment, the image data 64 is raw image data that is sent directly to the state estimator block 50. Alternatively, in another embodiment, the image data 64 includes lateral deviation e and road curvature ρ that are determined based on the raw image data by one or more modules, where the lateral deviation e and the road curvature ρ are used as virtual measurements by the state estimator block 50.

The IMU 28 includes one or more gyroscopes and one or more accelerometers, where the IMU 28 generates data indicative of the yaw rate ψ and a body acceleration of the vehicle 10. Specifically, the one or more gyroscopes measure the yaw rate ψ and the one or more accelerometers of the IMU 28 measures a longitudinal body acceleration Aₓ and a lateral body acceleration A_{y} of the vehicle 10. In embodiments, the system 12 includes one or more modules for preprocessing and conditioning the longitudinal body acceleration Aₓ and the lateral body acceleration A_{y}.

Continuing to refer to FIG. 2, the GPS 30 is in electronic communication and transmits GPS-based input 62 to the state estimator block 50. In one embodiment, the GPS-based input 62 includes GPS signals indicative of the velocity of the vehicle 10. Alternatively, in another embodiment, the GPS-based input 62 includes at least one of an initial longitudinal velocity Vₓ and an initial lateral velocity Vₓ that are determined based on GPS signals by dynamic filters, where the initial longitudinal velocity Vₓ and the initial lateral velocity Vₓ are utilized as virtual measurements by the state estimator block 50.

The state and covariance restart block 46 resets at least a portion of an initial state estimate \hat{x}(0|−1) and an associated initial state error covariance P(0|−1) in response to receiving one or more notifications that the vehicle 10 undergoing a specific reset event. The reset of the initial state estimate \hat{x}(0|−1) and the associated initial state error covariance P(0|−1) involves either a reset to last known values or initialization values. In the alternative, the reset of the initial state estimate \hat{x}(0|−1) and the associated initial state error covariance P(0|−1) involves the state estimator block 50 re-computing the initial state estimate \hat{x}(0|−1) and the associated initial state error covariance P(0|−1). The specific reset event indicates either a restart of the vehicle 10 and/or the one or more controllers 20, or the presence of one or more inoperable sensors within the vehicle 10. The initial state estimate \hat{x}(0|−1) includes various vehicle states such as, but not limited to, the lateral velocity [symbol] , the longitudinal velocity [symbol] , the longitudinal acceleration measurement offset dₓ, the lateral acceleration measurement offset d_{y}, a radius scaling factor, slip ratios, and axel torques.

In the embodiment as shown in FIG. 2, the one or more notifications include one or more of the following: a restart indicator 66 and an inoperable sensor indicator 68. Specifically, in an embodiment, the restart indicator 66 is represented as a Boolean variable and indicates when the vehicle 10 or the one or more controllers 20 have restarted. The inoperable sensor indicator 68 indicates that one or more of the plurality of sensors 16 (FIG. 1) are inoperable. It is to be appreciated that in some situations such as controller resets, the initial state estimate \hat{x}(0|−1) only requires a partial reset for example, to the bias/offset and scaling components of the full state estimate. Similarly, in embodiments, only the associated initial state error covariance P(0|−1) is reset, and the initial state estimate \hat{x}(0|−1) maintains the current value.

In some embodiments, the state and covariance restart block 46 re-computes the initial state estimate \hat{x}(0|−1) and the associated initial state error covariance P(0|−1) based on grade and surface values 70, which may be determined by the one or more vehicle controllers 34 (FIG. 1). In an embodiment, the grade and surface values 70 include at least one of the following: a road angle, a bank angle, and a coefficient of friction, however, it is to be appreciated that other variables may be used as well. Accordingly, it is to be appreciated that the state and covariance restart block 46 enhances filter consistency by ensuring the longitudinal velocity [symbol] and the lateral velocity [symbol] converge to the actual or true vehicle velocity. For example, if the vehicle 10 is driving along a racetrack, then the grade and surface values 70 would indicate a road angle, bank angle, or coefficient of friction of the racetrack, which would ensure accurate estimation of the longitudinal velocity [symbol] and the lateral velocity [symbol] .

Continuing to refer to FIG. 2, the covariance arbitration and adaptation block 48 adjusts a process noise covariance matrix Q(k−1) and a measurement noise covariance matrix R(k) for each time step k based on one or more process and noise variables related to the plurality of sensors 16 and a vehicle mode 80. The process and noise variables include sensor confidence interval information 74, measurement underweighting information 76, and process and measurement noise gain scheduling block 78. The sensor confidence interval information 74 is provided either by a sensor manufacturer or is part of a reliability assessment unit, where the sensor confidence interval information 74 includes data patterns indicating either an inoperable or a degraded sensor. The covariance arbitration and adaptation block 48 compares the sensor confidence interval information 74 with the data collected from the plurality of sensors 16 indicating the travel state of the vehicle 10, and calculates a reliability and confidence level of the data collected from the plurality of sensors 16 based on the sensor confidence interval information 74.

In embodiments, the system 12 determines a sensor fault that indicates one or more of the plurality of sensors 16 (FIG. 1) are either non-functional or exhibit degraded performance based on the comparison between the sensor confidence interval information 74 and the data collected from the plurality of sensors 16 indicating the travel state of the vehicle 10. The system 12 determines the sensor fault based on look-up tables saved in memory of the one or more controllers 20 or based on machine learning or artificial intelligence algorithms.

In response to determining the sensor fault, the system 12 generates the measurement underweighting information 76 that is sent to the covariance arbitration and adaptation block 48. The measurement underweighting information 76 weights the process noise covariance matrix Q(k−1) and the measurement noise covariance matrix R(k). Specifically, in response to determining the sensor fault, the covariance arbitration and adaptation block 48 increases a weight of the measurement noise covariance matrix R(k) and decreases a weight of the process noise covariance matrix Q(k−1). In response to determining a specific sensor or a specific subset of sensors have failed, the covariance arbitration and adaptation block 48 removes the specific sensor or the specific subset of sensors from consideration of a measurement set.

The process and measurement noise gain scheduling block 78 adjusts filter gain of the single state estimation scheme executed by the state estimation block 50. Specifically, the process and measurement noise gain scheduling block 78 adjusts a measurement noise gain C and a process noise gain G. In an embodiment, the measurement noise gain C and the process noise gain G are determined based on gain scheduling that is implemented by look-up tables. The look-up tables may be, for example, two-dimensional look-up tables or three-dimensional look-up tables.

The measurement noise gain C and the process noise gain G are combined and act as the filter gain of the single state estimation scheme executed by the state estimation block 50. It is to be appreciated that the filter gain of the single state estimation scheme is computed for each time step k, where increasing the filter gain indicates a rapid response to measurement in updating state, while decreasing the filter gain yields a slower response to the measurement. The covariance arbitration and adaptation block 48 receives the vehicle modes 80 as input and sends the vehicle modes 80 to the state estimator block 50. The state estimator block 50 determines an operating point of the single state estimation scheme based on the vehicle modes 80.

The state estimation block 50 fuses the plurality of inputs from the system 12 together to estimate the longitudinal velocity [symbol] , the lateral velocity [symbol] , the longitudinal acceleration measurement offset dₓ, and the lateral acceleration measurement offset d_{y} based on the single state estimation scheme. The single state estimation scheme is executed recursively and represents a common observer that fuses the data collected from the plurality of sensors 16 in combination with one or more initial vehicle states with a state-space model of the vehicle 10. Some types of state estimation schemes that may be used by the state estimation block 50 include, but are not limited to, extended Kalman filter, an unscented or sigma-point Kalman filter, a particle filter, an information filter, and an interacting multiple model filter as well as their square-root implementations.

Referring generally to the figures, the disclosed system provides various technical effects and benefits by providing a real-time algorithm for fusing and arbitrating multiple estimation schemes to accurately estimate the longitudinal and the lateral velocity of the vehicle under all operating conditions. In contrast, current approaches may not always be able to provide an accurate estimate of the longitudinal and the lateral velocity of the vehicle under some operating conditions such as, for example, slippery road conditions or at very low speeds. In preliminary testing, the disclosed approach resulted in almost a one hundred percent improvement when measuring lateral acceleration across various operating conditions. The disclosed system provides online compensation of sensor uncertainty, bias, gravity, bank, and grade through disturbance estimates (the longitudinal acceleration measurement offset dₓ and the lateral acceleration measurement offset d_{y}). Finally, the disclosed system enhances robustness by identifying non-functional sensors, configuring measurements, and adjusting covariances.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for estimating a lateral velocity and a longitudinal velocity of a vehicle including a plurality of sensors for monitoring data indicative of a travel state of the vehicle, the system comprising:
one or more controllers in electronic communication with the plurality of sensors, the one or more controllers executing instructions to:
receive the data indicative of the travel state of the vehicle from the plurality of sensors;
estimate at least one initial estimated state of the vehicle based on the data indicative of the travel state of the vehicle; and
fuse together the data indicative of the travel state of the vehicle with the at least one initial estimated state of the vehicle to determine the lateral velocity and a longitudinal velocity of the vehicle based on a single state estimation scheme.

2. The system of claim 1, wherein the data indicative of the travel state of the vehicle includes an angular wheel speed velocity of one or more wheels of the vehicle.

3. The system of claim 2, wherein the data indicative of the travel state of the vehicle includes a yaw rate and a body acceleration of the vehicle.

4. The system of claim 1, wherein the at least one initial estimated state of the vehicle is an initial longitudinal velocity of the vehicle.

5. The system of claim 4, wherein the one or more controllers execute instructions to estimate the initial longitudinal velocity based on a corner wheel velocity estimate and a wheel status signal.

6. The system of claim 4, wherein the one or more controllers execute instructions to estimate the initial longitudinal velocity based on global positioning system (GPS) signals.

7. The system of claim 1, wherein the one or more controllers execute instructions to:
collect raw image data of an environment surrounding the vehicle; and
determine a lateral deviation and road curvature based on the raw image data, wherein the lateral deviation and the road curvature are virtual measurements.

8. The system of claim 1, wherein the one or more controllers execute instructions to:
receive one or more notifications that the vehicle is undergoing a specific reset event; and
in response to receiving the one or more notifications, reset at least a portion of an initial state estimate and an associated initial state error covariance.

9. The system of claim 8, wherein the one or more controllers execute instructions to:
reset the initial state estimate and the associated initial state error covariance to either last known values or initialization values.

10. The system of claim 8, wherein the one or more controllers execute instructions to:
reset the initial state estimate and the associated initial state error covariance by re-computing the initial state estimate and the associated initial state error covariance.

11. The system of claim 8, wherein the one or more notifications include one or more of the following: a restart indicator and an inoperable sensor indicator.

12. The system of claim 11, wherein the restart indicator is represented as a Boolean variable and indicates when the vehicle or the one or more controllers have restarted.

13. The system of claim 11, wherein the inoperable sensor indicator indicates that one or more of the plurality of sensors are inoperable.

14. The system of claim 8, wherein the one or more controllers execute instructions to:
re-compute the initial state estimate and the associated initial state error covariance based on grade and surface values.

15. The system of claim 14, wherein the grade and surface values include at least one of the following: a road angle, a bank angle, and a coefficient of friction.

16. The system of claim 1, wherein the one or more controllers execute instructions to:
adjust a process noise covariance matrix and a measurement noise covariance matrix for each time step based on one or more process and noise variables related to the plurality of sensors and a vehicle mode.

17. The system of claim 16, wherein the one or more process and noise variables include one or more of the following: include sensor confidence interval information, measurement underweighting information, and process and measurement noise gain scheduling.

18. The system of claim 17, wherein the one or more controllers execute instructions to:
compare the sensor confidence interval information with the data collected from the plurality of sensors indicating the travel state of the vehicle;
calculate a reliability and confidence level of the data collected from the plurality of sensors based on the sensor confidence interval information; and
determine a sensor fault based on the comparison between the sensor confidence interval information and the data collected from the plurality of sensors indicating the travel state of the vehicle.

19. The system of claim 18, wherein the one or more controllers execute instructions to:
in response to determining the sensor fault, generate measurement underweighting information that weights the process noise covariance matrix and the measurement noise covariance matrix.

20. The system of claim 1, wherein the single state estimation scheme is one of the following: extended Kalman filter, an unscented or sigma-point Kalman filter, a particle filter, an information filter, and an interacting multiple model filter and a corresponding square root implementation.
